(19) United States
(12) Patent Application Publication
(10) Pub. No.: US 2016/0073652 A1
(43) Pub. Date: Mar. 17, 2016

(54) Blended Cheese and Meat Product

(71) Applicant: Kraft Foods Group Brands LLC, Northfield, IL (US)

(72) Inventor: Brian E. LeVine, Northbrook, IL (US)

(21) Appl. No.: 14/484,322

(22) Filed: Sep. 12, 2014

(51) Int. Cl. A23C 19/082

(52) U.S. Cl. CPC A23C 19/082

(57) ABSTRACT

A pasteurized and blended cheese product containing fatty meat is described. The product includes a portion of natural cheese or a mixture of natural cheeses and an amount of meat provided as inclusions dispersed in the portion of the natural cheese or mixture of natural cheeses. The blended meat and cheese product includes low levels of emulsifying salts to stabilize the meat fat and moisture form the meat, but yet retain the organoleptic characteristics of natural cheese.

### FIELD

The field relates to blended cheese and meat products, and more particularly, pasteurized blended cheese and meat products that remain homogeneous, substantially free from meat fat separation, and retain a natural cheese-like texture and flavor.

### BACKGROUND

A cheese and meat snack provides a new and convenient product for consumers. However, adding high levels of meat to a cooked cheese product tends to cause instability and processing issues, such as phase separation, when attempting to form a pasteurized cheese. In some cases, fat tends to separate from the meat and disperse in the cheese portion of the product. This meat fat separation results in less desirable cheese flavors, textures, and colors in the resultant product. In some circumstances, both fat and moisture separation from the meat form an unsightly surface coating on top of the cheese. When increasing the loading of meat in cheese, the levels of meat fat and moisture from the meat also increase. Thus, there is a challenge in maintaining the meat fat and moisture within the meat inclusions and limiting its separation into the cheese portion of the product while maintaining natural cheese characteristics to the cheese portion of the product.

Prior approaches to addressing these issues would be to decrease the level of meat added to the cheese in the finished product or utilize non-fatty meats, which tends to reduce the overall impact of the meat flavors and textures. Other typical solutions include the use of high levels of emulsifying salts in the cheese. However, this later solution tends to result in a processed cheese-like texture and flavor to the final product, which is not desirable when the expectation is a natural cheese.

In some instances, prior cheese products attempted to include certain modified starches or amounts of calcium reduced casein sources to help with stability issues in processed cheeses products. However, attempts at using such components to aid in the stability of cooked cheese with high levels of meat inclusions did not address the instability and processing issues when adding high levels of meat to cheese.

### SUMMARY

In one aspect, a pasteurized and blended cheese product containing meat is described herein. In one approach, the pasteurized and blended cheese product includes a portion of natural cheese or a mixture of natural cheeses and an amount of meat provided as inclusions dispersed in the portion of the natural cheese or mixture of natural cheeses. In some approaches, the meat includes about 2 percent or more meat fat and about 10 percent or more water. The cheese product also includes emulsifying salts, but not more than about 0.7 percent emulsifying salts so that the emulsifying salts preferentially emulsify the meat fat and water from the meat over any dairy fat and dairy moisture. In some approaches, the meat and emulsifying salts are in a weight ratio of meat to emulsifying salts of about 10:1 or greater amounts of meat.

In a second aspect, a method of preparing a pasteurized and blended cheese product containing meat is described. The method includes first combining about 20 percent to about 80 percent natural cheese or a mixture of natural cheeses, about 30 percent to about 80 percent water, meat pieces having about 2 percent or greater amounts of fat and about 10 percent or greater amounts of moisture, and no more than about 0.7 percent emulsifying salts into a cooker to form a cheese mixture. The mixture is heated, in some approaches, with steam injection, to a temperature between about 150° F. to about 165° F. to form a pasteurized cheese mixture. The pasteurized cheese mixture is then formed into a pasteurized and blended cheese product where the emulsifying salts emulsify the meat fat and moisture from the meat. In some approaches, the meat and emulsifying salts are in a weight ratio of meat to emulsifying salts of about 10:1 or greater amounts of meat.

The methods and products herein, even with the use of emulsifying salts typically used in processed cheese, retain the organoleptic characteristics of natural cheese. The products herein generally do not exhibit the characteristics of processed cheese.

### DETAILED DESCRIPTION

In one aspect, a blended cheese containing high levels of fatty meat is described in which the meat fat and moisture from the meat is preferentially emulsified by low levels of emulsifying salts that generally do not affect the structure of the cheese portion so that the cheese retains natural cheese characteristics. The meat fat may be bound or tied up with the meat or the meat fat may be emulsified within the cheese in an overall product that still retains natural cheese characteristics even with the use of emulsifying salts typically found in processed cheese-type products. The blended cheese, even with high levels of meat inclusions, remains substantially free of meat fat and moisture from the product upon experiencing pasteurization conditions and retains the flavors, textures, and consistency of natural cheese. By one approach, the compositions described herein include effective amounts of emulsification aides to preferentially emulsify the meat fat and moisture within the meat but, at the same time, not change the microstructure of the cheese in the blended cheese portion. By one approach, the pasteurized and blended cheese includes a portion of natural cheese or a mixture of natural cheeses and an amount of fatty meat provided as inclusions dispersed in the majority portion of the natural cheese or mixture of natural cheeses. The meat includes substantial levels of meat fat, moisture, and salts that are emulsified preferentially over dairy fats or dairy moisture whether the meat fat is retained within the meat or dispersed wholly or partially within the blended cheese portion upon pasteurizing.

In another aspect, the cheese and meat product includes a very low level of emulsifying aids, such as emulsifying salts, relative to the meat effective to preferentially emulsify the meat fat and moisture but not alter the cheese microstructure. In one approach, the blended cheese and meat includes emulsifying salts, but no more than about 0.7 percent emulsifying salts, in a weight ratio of fatty meat to emulsifying salts of about 10:1 or greater amounts of meat. Such low levels of emulsifying salts relative to the meat are effective so that the meat fat and moisture within the meat are preferentially emulsified over the dairy fats or moisture. That is, such low levels of emulsifying salts do not emulsify or change the structure of the cheese, but instead, preferentially interact with the meat to aid in emulsifying the meat fat and moisture whether it retains the meat fat and moisture within the meat inclusions themselves or maintains its stability within the cheese portions of the product. Additionally, such low levels of emulsifying salts do not alter the structure, textures, and flavors of the cheese portion so that it retains a natural cheese flavor and texture. The pasteurized and blended cheese product is also, in some approaches, substantially free of added emulsifiers as further described below.

It is generally understood that emulsifying salts are commonly used in processed cheese to modify a cheese microstructure to form a cheese that melts smoothly and resists separation when cooked. Emulsifying salts reduce the tendency for dairy fat in the cheese to coalesce and pool on the surface of the molten cheese during cooking and during subsequent heating. Casein is the dominant class of proteins present in milk, and is essentially the protein left in cheese after the whey (including whey proteins) has been drained off. Most types of casein have calcium phosphate groups. The higher the level of calcium, the less soluble the casein. While not wishing to be bound by theory, it is believed that the emulsifying salts in typical processed cheese complex with calcium ions in the cheese portion to solubilize casein protein, increase protein hydration and swelling to facilitate the emulsification of dairy fat, and to adjust and stabilize the pH in order to form a processed cheese that melts smoothly with a reduced tendency of dairy fat to coalesce and pool. Another function of the emulsifying salts in typical processed cheese is to structurally change the cheese and bind with the calcium provided from the casein to increase the solubility of the casein. While this emulsifying mechanism is somewhat less than fully defined, the anions from the emulsifying salts when added to processed cheese may combine with and remove calcium from the casein complex. This may cause rearrangement and exposure of both polar and nonpolar regions of the cheese proteins. The anions of the emulsifying salts may also participate in ionic bridges between protein molecules and thereby provide a stabilized matrix that can entrap the dairy fat in the processed cheese. Processed cheese, however, in view of these structural and pH changes has a distinctive texture and flavor that is different than natural cheese and not desired or expected by consumers in a product that is intended to be a natural cheese.

In this disclosure, however, the low levels of emulsifying salts are not believed to be bound with the calcium provided from the casein in the cheese portion consistent with traditional processed cheese products and as suggested above. Rather, the low levels of emulsifying salts predominately or preferentially interact or bind with the meat or components within the meat without substantially binding or interacting with the calcium or casein in the cheese portion. To this end, the microstructure of the cheese portion does not take on the characteristics of a processes cheese, but retains the characteristics more so of natural cheese. The emulsifying salts, rather, control the meat fat so as to retain the meat fat within the meat inclusions themselves or stably emulsify the meat fat within the cheese portions. While not wishing to be limited by theory, it is believed that the emulsifying salts may form an interface about the outer surface of the meat inclusions or meat fat, which may aid in preferentially emulsifying in the meat and meat fat over the dairy fat.

In some alternative approaches, the blended cheese and meat products herein may also include effective amounts of an optional modified starch selected to provide amylopectin and substantially no amylose. As discussed more herein, the select modified starches effectively provide a uniform distribution of amylopectin with substantially no intact starch granules and substantially no starch aggregation or agglomerates in the final cheese product. The starches also provide no or substantially no amylose. Thus, the cheese portion of the cheese and meat product may include, in some optional approaches, effective ratios of uniformly distributed amylopectin to amylose to provide no texture or flavor to the final processed cheeses. If included, the blended cheese may include about 0.1 to about 10 percent of the modified starch.

In other approaches, the blended cheese and meat product may also include effective amounts of an optional dairy protein source, such as calcium reduced casein source used with or combined with the natural cheese portion of the product. The dairy protein source may be concentrated dairy protein sources. If used, the optional calcium reduced casein source may have less than about 350 ppm calcium per percent of casein and, in some approaches, less than about 200 ppm calcium per percent of casein. If included, the blended cheese may include about 0.8 to about 25 percent of the optional dairy protein source and/or the calcium reduced casein source.

Turning to more of the specifics, the present disclosure provides a blended cheese and meat product that is capable of withstanding pasteurizing temperatures and conditions without phase separation from the high levels of fatty meat inclusions therein. The product retains organoleptic characteristics of natural cheese even with high levels of fatty meat therein.

First, the cheese portion of the blended cheese and meat product includes a natural cheese or blend of natural cheeses. By one approach, the blended cheese may include about 20 to about 80 percent of natural cheese, in other approaches, about 50 to about 70 percent natural cheese. Suitable natural cheeses may be pasteurized or unpasteurized cheese made by curdling milk by some combination of rennet, rennet substitutes, and acidification. The milk may be unfiltered or filtered, such ultrafiltered milk. The natural cheese used in the present disclosure may be freshly made or aged, full fat, lower fat, or no fat cheese made from full fat milk, 2% milk, or skim milk. Natural cheese types may include, for example, cheddar, gouda, mozzarella, provolone, brie, Monterey jack, and any other suitable natural cheese for use in a cheese. A mixture of two or more natural cheeses may be selected to provide the desired flavor profile. In some approaches, the natural cheese includes casein and essentially no whey. The casein provided from the natural cheese is generally non-calcium reduced casein and tends to include about 200 to about 350 ppm of calcium per percent of casein and, in some approaches, about 300 to about 350 ppm of calcium per percent of casein. As used herein, essentially no whey generally means less than about 1 percent, in other approaches, less than about 0.5 percent, and in yet other approaches, no whey.

Next, the meat portion of the blended cheese and meat product is substantial levels of fatty meat provided in the form of meat inclusions, such as discrete whole meat pieces, bits, or chunks, dispersed or blended throughout the blended cheese portion. By one approach, the meat is bacon, pepperoni, salami, ham, beef, roast beef, steak, chicken, turkey, sausage, chorizo and mixtures thereof. In some approaches, the blended cheese and meat product includes about 2 to about 50 percent fatty meat in the form of inclusions or discrete pieces of the meat uniformly dispersed within the blended cheese portion. In other approaches, the product includes about 8 to about 40 percent meat and, in yet other approaches, about 10 to about 30 percent meat. Generally, the meat pieces range in size from about 3 mm diced to about 9 mm diced. In yet other approaches, the meat pieces may have irregular shapes, are not substantially retained on a USS ¼ inch sieve, and are substantially retained on a USS#20 sieve.

These fatty meat sources all have substantial levels of meat fat and moisture. In some approaches, the meat has about 2 percent or more meat fat and about 10 percent or more water and, in other approaches, about 15 to about 40 percent meat fat (in yet other approaches, about 20 to about 30 percent) and about 10 to about 35 percent water (in other approaches, about 15 to about 25 percent). Such substantial levels of meat fat and water tend to cause stability problems to the cheese during pasteurizing when attempting to retain natural cheese characteristics. The meat inclusions may also include about 10 to about 51 percent meat protein (in some approaches, about 25 to about 51 percent) and about 1 to about 8 percent salts (in some approaches, about 3 to about 8 percent salts). For instance, bacon pieces that may be used in the cheese blends herein may include about 12 to about 35 percent moisture (in some approaches, about 12 to about 29 percent moisture), about 26 to about 39 percent meat fat (in some approaches, about 26 to about 37 percent meat fat), about 25 to about 46 percent meat protein (in some approaches, about 34 to about 46 percent meat protein), and about 3 to about 6 percent salt (in some approaches about 3 to about 5 percent salt). Alternatively, bacon bits that may be used in the blended cheeses in this disclosure may have about 11 to about 33 percent moisture, about 18 to about 32 percent meat fat, about 31 to about 51 percent meat protein, and about 3 to about 8 percent salt. (The percentages of the meat in this paragraph are relative to the meat.)

As mentioned above, the blended cheese and meat product includes uncharacteristically low levels of emulsifying salts, which is contrary to the expectation of a product with high levels of meat and unbound or free fat sources. While not wishing to be limited by theory, the low levels of emulsifying salts do not structurally effect or change the casein proteins in the blended cheese portion but rather interact or bind with the meat instead. In some instances, the low levels of emulsifying salts may preferentially emulsify the meat by interacting with the surfaces of the meat at a meat-cheese interface or the surfaces of the meat fat at a meat fat-cheese interface without substantially interacting with the casein or calcium ions in the cheese.

In some approaches, the blended cheese and meat product includes no more than about 0.7 percent emulsifying salts and, in some further approaches, may also have levels of emulsifying salts within a ratio of meat-to-emulsifying salt of about 10:1 or greater amounts of meat. In other approaches, the cheese may have no more than about 0.7 percent emulsifying salts with a ratio of meat-to-emulsifying salt of about 12:1 to about 50:1 and, in yet other approaches, about 12:1 to about 26:1 ratio of meat-to-emulsifying salts. As discussed more in the Examples below, a blended cheese product with a ratio of meat-to-emulsifying salts of about 6:1 or less meat results in an unfavorable cheese with a reduced natural cheese flavor impact and a processed cheese-like texture. Such organoleptics impact is undesirable in a cheese that is intended to be a natural cheese product.

As noted above, the blended cheese and meat product may include no more than about 0.7 percent of the emulsifying salts in the discovered meat ratio. In other approaches, the blended cheese and meat product may include about 0.25 to about 0.7 percent emulsifying salts, in other approaches, about 0.25 to about 0.6 percent emulsifying salts, in yet other approaches, about 0.25 to about 0.5 percent, and in yet further approaches, about 0.3 to about 0.6 percent. By some approaches, the emulsifying salts are sodium and potassium citrates, monophosphates, and polyphosphates. Examples include disodium phosphate, disodium phosphate duohydrate, trisodium phosphate duodecahydrate, trisodium citrate, sodium tripolyphosphate, sodium hexametaphosphate, and the like. Combinations of these emulsifying salts may also be used.

While typical processed cheeses utilize emulsifying salts to complex with calcium ions in the cheese to solubilize the casein protein, increase protein hydration and swelling, to facilitate emulsification of cheese fat, and to adjust and stabilize pH, in the approaches herein, however, the low levels of emulsifying salts do not generally interact with the cheese portion, but instead preferentially interact with/emulsify the meat fat and moisture from the meat and, in some approaches, form an interface with the meat or meat fat. It is believed that the emulsifying salts preferentially emulsify the meat fat and moisture over the dairy fat and dairy moisture because the same cheese composition can be prepared without meat and without emulsifying salts and, upon cooking and pasteurization (as described herein), no dairy fat and moisture separation occurs. If meat is added to such cheese composition without emulsifying salts, upon cooking and pasteurization, then meat fat and meat moisture separation occurs. Thus, with the unique ratios of emulsifying salts discovered herein, the emulsifying salts preferentially emulsify the meat fat over the dairy fat because the cheese is free from meat fat separation and retains the characteristics of natural cheese.

The cheese is also generally free of other added non-salt based emulsifiers, which can also degrade the textures and flavors of a natural cheese product. In some approaches, the cheeses herein are free of common emulsifiers such as eggs, lecithin, monoglycerides, diglycerides, polyglycerol polyricinoleate (PGPR), polysorbate 60, phospholipids, egg yolk, polysorbate 80, sorbitan monostrearate, DATEM (diacetyl tartic acid esters), propylene glycol and mixtures thereof. As used herein, generally free of or substantially free of these non-salt based emulsifiers generally means such amounts provide no functional benefit and may be less than about 1 percent, in other approaches, less than about 0.5 percent, in yet other approaches, less than about 0.1 percent and, in yet other approaches, none at all.

Optionally, the cheese may include about 0.1 weight percent to about 10 weight percent of a modified starch containing amylopectin and substantially no amylose. In other approaches about 0.8 to about 3 percent modified starch is used. The modified starch is effective to provide a uniform distribution of the amylopectin in the final cheese with substantially no intact starch granules and substantially no starch agglomerates with less than, in some approaches, about 0.1 percent amylose so that the processed cheese has substantially no amylose therein. In yet other approaches, the amylopectin and amylose from the modified starch are selected to be in a form and in a ratio within the final cheese effective to provide substantially no texture or flavor to the processed cheese. In some approaches, the modified starch aids in stabilizing the dairy fat and moisture of the cheese portion of the product.

Suitable starches may include any modified starches treated to provide the desired processing functionality of viscosity and water management during heating, yet disappear functionally in the final product with the unique distribution of amylopectin and amylose. The modified starch may be derived from any suitable starch source, such as corn, wheat, potato, tapioca, waxy maize, sago, rice, and the like. In one approach, the starch may be derived from waxy starches, such as waxy maize, waxy rice, and waxy sorghum, or root starches such as potato, sweet potato, yams, taro and arrow root. Any suitable modified starch or combinations thereof may be used. The modified starch may be an instant starch, or a pre-cooked starch paste. The pre-cooked starch paste may undergo additional processing, such as shear, prior to being combined with a cheese mixture. In one approach, modified corn starch is used.

In one approach, the modified starch may be substituted starches. The modified substituted starch may be lightly substituted, such as to a degree of substitution less than about 0.2 D.S., or from about 0.1 to about 0.2 D.S., or in some cases less than about 0.1 D.S. The degree of substitution may be such that the starch does not need to be cross-linked during the modification process. Substitution may lower gelatinization temperature, resulting in a starch with a tendency to develop viscosity earlier in the heating process compared to the unmodified parent starch, starches with other modifications such as cross-linking, or starches with higher gelatinization temperatures. In some approaches herein, the modified starches may have a gelatinization temperature of about 65° C. to about 75° C. The lightly substituted starch is less resistant to shear, such that the starch granule may be degraded or ruptured by the application of shear. In some approaches, the starch granules tend to be substantially ruptured and only a few or substantially only a few intact and swollen starch granules remain intact in a cooked paste or slurry of the starch. In one aspect, the starch may be a mono-substituted waxy corn starch having one hydroxypropyl group substituted for hydrogen in the starch to form a starch ester.

In other approaches, it is believed that select ratios of the amylopectin to amylose provided by the modified starch are effective in achieving the unique processing and final textural and flavor characteristics discovered herein. For instance and in yet one approach, the processed cheese has a ratio of amylopectin to amylose from about 20 to about 200, in other approaches, about 20 to about 100, and in yet other approaches, about 50 to about 100. In some approaches, processed cheese has no amylose at all.

In another aspect of the processed cheeses herein, the amylopectin is uniformly distributed in the final cheese product. Thus, the amylopectin is not agglomerated, aggregated, or pooled in various portions of the cheese, but rather uniformly or consistently blended in or throughout the cheese. This can easily be identified via a Lugol's stain analysis where agglomerated or aggregated amylopectin tends to be visible as bands of discrete rust colored portions in the cheese.

In some approaches, the blended cheese and meat may further include optional hydrocolloid stabilizers, but less than about 0.5 percent hydrocolloid stabilizers. Higher amounts of hydrocolloids may inhibit flavor release and yield undesirable texture and eating quality. Hydrocolloid stabilizers include natural and modified gums. Natural gums may include agar-agar, carrageenan, gelatin, guar gum, gum arabic, xanthan gum, pectin, and the like. Modified gums may include cellulose derivatives such as carboxymethyl cellulose, sodium alginate, and the like.

The blended cheese and meat products may also include further sources of optional dairy proteins such as milk protein concentrate, whey protein concentrate, whey protein isolate, whey, nonfat dry milk and mixtures thereof. In some alternative approaches, the optional dairy proteins may be calcium reduced, such as described in U.S. 2003/0054068, which is incorporated herein by reference. If used, the optional dairy protein sources may be included in the blended cheese and meat product in about 0 to about 30 percent, in some approaches, about 1 to about 30 percent, and in yet other approaches, about 1 to about 3 percent. In some approaches, the optional dairy protein source provides protein fortification. If used, the optional calcium reduced casein may be included in amounts up to about 25 percent, such as about 0.8 percent to about 25 percent, in other approaches, about 0.8 percent to about 5 percent and, in yet other approaches, about 1 to about 3 percent. In some approaches, the calcium reduced casein may aid in stabilizing the dairy fat and moisture of the cheese portion of the product.

If included in the cheese, the calcium reduced casein source should have less than about 350 ppm calcium per percent casein, in some cases, less than about 300 ppm calcium per percent casein, in other cases, less than about 220 ppm calcium per percent casein, and in other cases less than about 175 ppm calcium per percent casein. The calcium reduced casein source may range from a liquid to a powder. For example, one commercially available calcium reduced casein source is Nutrilac CH-7813 from Arla Foods (a powder which contains about 61.5 percent casein and has a calcium level of about 10,400 ppm); it contains about 170 ppm calcium per percent casein. Calcium reduced liquids obtained from skim milk liquid can also be used and may have a moisture level of about 82.8 percent, a casein level of about 10.4 percent, and a calcium level about 1,440 ppm. Thus, it contains about 139 ppm calcium per percent casein.

In one approach, the calcium reduced casein source contained in the cheese described herein may be produced using ultrafiltration, diafiltration, cation exchange, acidification, dialysis, chelation, as well as similar techniques and combinations thereof. One preferred calcium reduced casein source can be obtained using ultrafiltration alone or in combination with diafiltration.

The blended cheese and meat products of the present disclosure including high levels of meat and low levels of emulsifying salts are stable upon pasteurizing conditions. In one approach, the cheeses herein are stable by exhibiting no phase separation of meat fat and moisture from the meat (as well as the dairy fat and moisture) upon experiencing pasteurizing conditions. As used herein, pasteurizing conditions generally means exposing the blended cheese and meat product to temperatures up to about 165° F. and, in other approaches, about 150° F. to about 165° F. and, in yet other approaches, about 159° to about 165° F. The blended meat and cheese product may be exposed to these temperatures for not less than 30 seconds and up to about 30 minutes. In some approaches, the cheese product may be exposed to such temperatures for about 1 to about 2 minutes. In other approaches, blended meat and cheese product may be exposed to such temperatures for about 1 to about 3 minutes. In such approaches, the resulting cheese product is pasteurized and remains generally homogenous, shows no signs of meat-sourced fat or moisture separation (i.e., meat-sourced moisture watering off or meat-fat oiling off) during heating, and otherwise has a smooth and homogeneous consistency and texture resembling natural cheese.

As used herein, the discussion of an ingredient being absent from, not in significant levels, not present, having substantially no, not included in, and/or present in essentially no amounts in the cheese generally means that the ingredient is present at about 0.5 percent or less, in other approaches, about 0.1 percent or less, in yet other approaches, about 0.05 percent or less, and in some cases not present at all meaning that such ingredient provides no functionality to the compositions. Additionally, if a particular ingredient is not discussed in this disclosure, then in some approaches, it will be considered to not be in a significant level within the compositions discussed herein. The blended cheeses herein may also include various optional ingredients including spices, flavors, seasonings, color, sorbic acid (or other preservation agents), salts (sodium chloride and the like), condiments (such as jalapeno peppers and the like) and the like as needed for flavor, color, and/or texture so long as such optional ingredients do not affect the natural cheese flavor and texture and do not impart instability. By some approaches, such optional ingredients may be included at about 5 percent of each or less or about 5 percent total or less (in other approaches, about 2 percent of each or less or about 2 percent total or less).

Turning now to the method of manufacturing the blended cheese and meat products of the present disclosure. By one approach, the cheese may be produced by blending together natural cheese or a mixture of natural cheeses, water, meat and other ingredients in a mixing tank or other blender or cooker. The mixture is then heated under agitation for a time and temperature to achieve pasteurization and to form a uniform mixture or blend. By one approach, the mixture is heated via direct steam injection to about 165° F. and in other approaches about 155° F. to about 165° F. for about 2 minutes or less and, in some approaches, about 1 to about 2 minutes.

The cooked cheese is then packaged into a desired shaped and cooled to refrigeration temperatures (about 35 to about 45° F.). By one approach, the cheese is in the form of bricks, sticks, loaf, slice, crumbles, cubes, cuts, or other shapes. The cheese may also be in the form of a sauce or spread. After cooking, the resultant blended cheese and meat product may have a moisture content of about 30 to about 80 percent water and, in other approaches, about 40 to about 50 percent water. By some approaches, the more solid forms of the product (such as bricks, sticks, loaf, slices and the like) will generally have a moisture content of about 30 to about 60 percent while the spread and sauce forms will generally have a moisture content of about 50 to about 80 percent. The overall moisture may be provided both from moisture in the cheese and meat as well as from the steam injection during the cooking process. The steam cooking will contribute about 5 to about 10 percent of the total moisture in the product.

A better understanding of the present disclosure and its many advantages may be clarified with the following examples. The following examples are illustrative and not limiting thereof in either scope or spirit. Those skilled in the art will readily understand that variations of the components, methods, steps, and devices described in these examples can be used. Unless noted otherwise, all percentages, ratios, and parts noted in this disclosure are by weight.

### EXAMPLES

### Example 1

A pasteurized blended cheese and meat product was prepared based on the compositions of Table 1 below. The ingredients were mixed together and heated under agitation to temperatures between about 159° F. and about 165° F. by direct steam injection and held for about 1 to 2 minutes for pasteurization to form a cooked cheese blend with dispersed meat inclusions. The cooked cheese was then packaged into a block form and cooled to refrigeration temperature (35 to 45° F.). Each composition of Table 1 produced a successful product that did not exhibit a processed cheese texture and had little to no observable meat fat or moisture separation even though the level of emulsifying salts relative to the meat was so low.

TABLE 1

| | Sample 1, | Sample 2, | Sample 3, |
|---|---|---|---|
| Ingredient | wt % | wt % | wt % |
| Cheddar Cheese | 63.79 | 63.99 | 63.46 |
| Water | 16.25 | 16.13 | 10.88 |
| Bacon, ready-to-eat, pieces | 8 | 8 | — |
| Pepperoni, Diced | — | — | 15 |
| Milk Protein concentrate | 6.21 | 5.82 | 5.98 |
| Modified corn starch | 3 | 3 | 0.8 |
| Sodium chloride | 0.95 | 0.95 | 0.63 |
| Emulsifier-Disodium phosphate | 0.31 | 0.63 | 0.31 |
| duohydrate | | | |
| Sorbic acid | 0.18 | 0.18 | 0.18 |
| Colors, flavors, and seasonings | 1.31 | 1.3 | 2.76 |
| Meat-to-Emulsifier Ratio | 25.8:1 | 12.6:1 | 48.4:1 |

### Comparative Example 1

A similar pasteurized blended cheese and meat product was prepared as described in Example 1, but with higher levels of emulsifying salt relative to the meat. The cheese of this Example was prepared based on the composition in Table 2 and similar to the cheeses of Example 1. The cheese of this example had a reduced natural cheese flavor impact and a processed cheese-like texture and flavor.

TABLE 2

| | (Comparative) |
|---|---|
| Ingredient | Sample 4, wt % |
| Cheddar Cheese | 72.87 |
| Water | 11.2 |
| Bacon, ready-to-eat, diced | 9 |
| Pepperoni, Diced | — |
| Milk Protein concentrate | 0.16 |
| Modified corn starch | 3 |
| Sodium chloride | 0.73 |
| Emulsifier-Disodium phosphate | 1.56 |
| duohydrate | |
| Sorbic acid | 0.18 |
| Colors, flavors, and seasonings | 1.3 |
| Meat-to-Emulsifier Ratio | 5.7:1 |

### Example 2

Further experiments were conducted to evaluate the effect of finished product cook temperature on cheese formulas containing about 10% meat with and without emulsifying salts. Samples 5, 6, and 7 were prepared as set forth in Table 3 below.

TABLE 3
Formulations

| | Sample 5, | Sample 6, | Sample 7, |
|---|---|---|---|
| Ingredient | wt % | wt % | wt % |
| Cheddar Cheese | 75.43% | 74.65% | 74.65% |
| Annatto Oil Soluble | 0.036% | 0.036% | 0.036% |
| Color (1.5% Bixin) | | | |
| Oleoresin Paprika | 0.016% | 0.016% | 0.016% |
| Water + Steam | 13.79% | 13.94% | 13.94% |
| Condensate | | | |
| Bacon, pieces | 10.00% | 10.00% | 10.00% |
| Sodium Chloride | 0.54% | 0.55% | 0.55% |
| Disodium Phosphate | 0.00% | 0.63% | 0.63% |
| Sorbic Acid | 0.18% | 0.18% | 0.18% |

The moisture target for each sample was approximately 42%. The procedures employed were as follows: For sample 5, add all ingredients to steam injection cooker, heat to about 190° F. and hold for 1 minute. Collect samples and refrigerate. For sample 6, add all ingredients to steam injection cooker, heat to 190° F. and hold for 1 minute. Collect samples and refrigerate. For sample 7, add all ingredients to steam injection cooker, heat to 162° F. and hold for 1 minute. Collect samples and refrigerate.

It was observed that samples 5 and 6 exhibited some meat product separation (water and oil phases) during cooking, particularly towards the end of the cook cycle. Sample 7 did not exhibit meat component separation during cooking.

After refrigeration, sample 5 exhibited two layers; a top, thin viscosity layer and a bottom, firm layer with visual separation of meat fat and water (non-homogenous). Sample 6 exhibited a single layer of a firm product, but was also non-homogenous as it demonstrated visual separation of meat fat. Sample 7 exhibited a single layer that was a firm, homogenous product with no visual meat fat or moisture separation. Thus, heating a blended cheese and meat product containing about 10 percent bacon and low levels or no emulsifying salts results in a non-homogenous finished product with observable meat fat and moisture separation after cooking to temperatures above about 165° F., such as 190° F., and cooling. Separation of the water and oil phases was visually apparent in samples 5 and 6. On the other hand, use of about 0.625% emulsifying salt in a cheese product containing about 10 percent bacon (meat to emulsifying salt ratio of about 16:1) and heating to only about 162° F. produces a homogenous finished product with little or no processed cheese textures and colors.

### Comparative Example 2

An experiment was conducted to evaluate the stability of a blended meat and cheese product without emulsifying salts but with modified starches and calcium reduced casein sources only. This experiment studied cheese products with about 8 percent meat and either 2.27 percent calcium-reduced milk protein concentrate or 3 percent modified starch as set forth in Table 4 below.

TABLE 4
Formulations

| | Sample 8, | Sample 9, |
|---|---|---|
| Ingredient | wt % | wt % |
| Cheddar Cheese | 39.9 | 73.9 |
| Monterey Jack Cheese | 39.9 | — |
| Annatto color | 0.036 | 0.036 |
| Water | 8.15 | 12.4 |
| Bacon, pieces | 8 | 8 |
| Sodium Chloride | 0.18 | 0.54 |
| Modified Starch | — | 3 |
| Calcium-reduced MPC | 2.27 | — |
| Milk protein concentrate | — | 0.57 |
| Seasoning, color, spices | 1.27 | 1.26 |
| Sorbic Acid | 0.18 | 0.18 |

The ingredients of samples 8 were mixed and heated in a steam injection cooker to about 165° F. and then held for about 2 minutes at a minimum temperature of about 162° F. The samples were then collected and refrigerated. The sample exhibited meat fat separation during cooking and upon packing indicating that the calcium-reduced milk protein concentrate was not effective at emulsifying the meat fat and moisture from the meat.

The ingredients of sample 9 were mixed and then heated in a steam injection cooker to about 158° F. and held for about 1 minute. The sample was collected and refrigerated. This sample also exhibited meat fat separation during cooking, particularly toward the end of the cook cycle and upon packaging indicating that the modified starch was not effective at emulsifying the meat fat and moisture from the meat.

It will be understood that various changes in the details, materials, and arrangements of formulations and ingredients, which have been herein described and illustrated in order to explain the nature of the method and compositions, may be made by those skilled in the art within the principle and scope of the description and claims herein.

What is claimed is:

1. A pasteurized and blended cheese product containing meat, the pasteurized and blended cheese product comprising:
a portion of natural cheese or a mixture of natural cheeses;
an amount of meat provided as inclusions dispersed in the portion of the natural cheese or mixture of natural cheeses, the meat including about 2 percent or more meat fat;
emulsifying salts, but not more than about 0.7 percent emulsifying salts, so that the emulsifying salts preferentially emulsify the meat fat and water from the meat; and
the pasteurized and blended cheese product is substantially free of added emulsifiers.

2. The pasteurized and blended cheese product of claim 1, wherein the amount of meat and the emulsifying salts are in a weight ratio of meat to emulsifying salts of about 10:1 or greater amounts of meat.

3. The pasteurized and blended cheese product of claim 1, wherein the pasteurized and blended cheese product contains about 2 percent to about 50 percent meat and about 0.25 percent to about 0.7 percent emulsifying salts.

4. The pasteurized and blended cheese product of claim 1, wherein the pasteurized and blended cheese product contains about 8 percent to about 40 percent meat.

5. The pasteurized and blended cheese product of claim 1, wherein the pasteurized and blended cheese product contains about 10 percent to about 30 percent meat.

6. The pasteurized and blended cheese product of claim 1, wherein the pasteurized and blended cheese product contains about 0.25 percent to about 0.6 percent emulsifying salts.

7. The pasteurized and blended cheese product of claim 2, wherein the weight ratio of meat to emulsifying salts is about 12:1 to about 50:1.

8. The pasteurized and blended cheese product of claim 1, wherein the meat is selected from the group consisting of bacon, salami, pepperoni, ham, beef, roast beef, steak, chicken, turkey, sausage, chorizo, and mixtures thereof.

9. The pasteurized and blended cheese product of claim 1, further comprising a modified starch.

10. The pasteurized and blended cheese product of claim 9, wherein the modified starch contains amylopectin and substantially no amylose.

11. The pasteurized and blended cheese product of claim 10, further comprising a uniform distribution of amylopectin and substantially no intact starch granules in the portion of natural cheese or mixture of natural cheeses and wherein the portion of cheese or mixture of natural cheese includes substantially no starch agglomerates with less than about 0.1 percent amylose.

12. The pasteurized and blended cheese product of claim 1, further comprising a calcium reduced casein source providing calcium reduced casein wherein the pasteurized and blended cheese product includes a total amount of casein provided from non-calcium reduced casein and the calcium reduced casein.

13. The pasteurized and blended cheese product of claim 1, wherein the pasteurized and blended cheese product is in the form of a stick, slice, loaf, brick, shred, crumble, cube, cut, sauce, or spread.

14. The pasteurized and blended cheese product of claim 1, wherein the pasteurized and blended cheese product can be heated up to about 165° F. without substantial separation of meat fat.

15. A method of preparing a pasteurized and blended cheese product containing meat, the method comprising:
combining about 20 percent to about 80 percent natural cheese or a mixture of natural cheeses, about 30 percent to about 80 percent water, meat pieces having about 2 percent or greater amounts of fat and about 10 percent or greater amounts of moisture, and emulsifying salts, but no more than about 0.7 percent emulsifying salts, into a cooker to form a cheese mixture, the cheese mixture being substantially free of added emulsifiers;
heating the cheese mixture to a temperature between about 150° F. to about 165° F. to form a pasteurized cheese mixture; and
forming the pasteurized cheese mixture into a pasteurized and blended cheese product where emulsifying salts emulsify the meat fat and moisture from the meat.

16. The method of claim 15, further including a weight ratio of meat to emulsifying salts of about 10:1 or greater amounts of meat.

17. The method of claim 15, wherein the cheese mixture contains about 2 percent to about 50 percent meat pieces and about 0.25 percent to about 0.7 percent emulsifying salts.

18. The method of claim 15, wherein the cheese mixture contains about 8 percent to about 40 percent meat pieces.

19. The method of claim 15, wherein the cheese mixture contains about 10 percent to about 30 percent meat.

20. The method of claim 15, wherein the cheese mixture contains about 0.25 percent to about 0.6 percent emulsifying salts.

21. The method of claim 16, wherein the weight ratio of meat to emulsifying salts is about 12:1 or greater levels of meat.

22. The method of claim 15, wherein the meat is selected from the group consisting of bacon, salami, pepperoni, ham, beef, roast beef, steak, chicken, turkey, sausage, chorizo, and mixtures thereof.

23. The method of claim 15, wherein the cheese mixture further comprises a modified starch.

24. The method of claim 23, wherein the modified starch contains amylopectin and substantially no amylose.

25. The method of claim 24, wherein the pasteurized cheese mixture includes a uniform distribution of amylopectin and substantially no intact starch granules and substantially no starch agglomerates with less than about 0.1 percent amylose.

26. The method of claim 15, wherein the cheese mixture further comprises a calcium reduced casein source providing calcium reduced casein, the cheese mixture includes a total amount of casein provided from non-calcium reduced casein and the calcium reduced casein.

27. The method of claim 15, wherein the cheese product is formed into a cheese stick, slice, loaf, brick, shred, crumble, cube, cut, sauce, or spread.
